(19) United States
(12) Patent Application Publication
(10) Pub. No.: US 2025/0258627 A1
(43) Pub. Date: Aug. 14, 2025

(54) PRINT CONTROL APPARATUS, PRINT CONTROL SYSTEM, AND STORAGE MEDIUM

(71) Applicant: Konica Minolta, Inc., Tokyo (JP)

(72) Inventors: Akira INOUE, Tokyo (JP); Hisataka FUNAKAWA, Toyohashi-shi (JP); Tatsuro YAMAMURO, Kashiwa-shi (JP); Keigo ITOH, Tokyo (JP)

(21) Appl. No.: 19/042,917

(22) Filed: Jan. 31, 2025

(30) Foreign Application Priority Data
Feb. 9, 2024 (JP) 2024-018349

(51) Int. Cl. G06F 3/12

(52) U.S. Cl. CPC G06F 3/1203; G06F 3/1237; G06F 3/1284

(57) ABSTRACT

A print control apparatus includes a hardware processor. The hardware processor receives a plurality of small jobs transmitted from a client terminal based on a print instruction, performs control to perform printing based on the received small jobs, accepts a job cancel instruction that is a printing terminate instruction or a printing interrupt instruction, and when the job cancel instruction is accepted during reception of the plurality of small jobs, performs control such that the printing based on the small jobs is terminated or interrupted.

### CROSS-REFERENCE TO RELATED APPLICATIONS

The entire disclosure of Japanese Patent Application No. 2024-018349 filed on Feb. 9, 2024, is incorporated herein by reference in its entirety.

### BACKGROUND OF THE INVENTION

### Technical Field

The present invention relates to a print control apparatus, a print control system, and a storage medium.

### Description of Related Art

Conventionally, jobs of a small size (hereinafter referred to as “small job”) are continuously sent to an image forming apparatus to sequentially perform printing in some cases. In such printing, even if the printing is cancelled due to some trouble during the printing, the cancel is not completed in time, and most of the jobs are printed.

In this regard, for example, Japanese Unexamined Patent Publication No. 2010-282412 discloses a technique of stopping printing after cancel by also monitoring and canceling a job in a spooler.

However, the technology described in Japanese Unexamined Patent Publication No. 2010-282412 can cope with only cancel from a client-terminal side, and does not consider cancel from the image forming apparatus-side. In addition, a job that enters after cancel is not cancelled. Therefore, it has been difficult to quickly stop subsequent jobs when a trouble occurs.

### SUMMARY OF THE INVENTION

The present invention has been conceived in consideration of the above-described points, and an object of the present invention is to provide a print control apparatus, a print control system, and a storage medium that can promptly stop subsequent jobs upon accepting a job cancel instruction.

To achieve at least one of the abovementioned objects, according to an aspect of the present invention, a print control apparatus reflecting one aspect of the present invention is a print control apparatus including: a hardware processor, wherein the hardware processor, receives a plurality of small jobs transmitted from a client terminal based on a print instruction, performs control to perform printing based on the received small jobs, accepts a job cancel instruction that is a printing terminate instruction or a printing interrupt instruction, and when the job cancel instruction is accepted during reception of the plurality of small jobs, performs control such that the printing based on the small jobs is terminated or interrupted.

According to an aspect of the present invention, a print control system reflecting one aspect of the present invention is a print control system, including: a hardware processor, wherein the hardware processor, receives a plurality of small jobs transmitted from a client terminal based on a print instruction, performs control to perform printing based on the received small jobs, and accepts a job cancel instruction that is a printing terminate instruction or a printing interrupt instruction; a print control apparatus; a client terminal that transmits a plurality of small jobs based on the print instruction; and an image forming apparatus that executes a printing operation for the small job, wherein, the hardware processor performs control so as to terminate or interrupt printing based on the small job when the job cancel instruction is accepted during reception of the plurality of small jobs.

According to an aspect of the present invention, a storage medium reflecting one aspect of the present invention is a non-transitory computer-readable storage medium storing a program causing a computer that controls a printing operation to execute, receiving a plurality of small jobs transmitted from a client terminal based on a print instruction, performing control to perform printing based on the received small job; accepting a job cancel instruction that is a printing terminate instruction or a printing interrupt instruction, and when the job cancel instruction is accepted during reception of the plurality of small jobs, performing control such that the printing based on the small jobs is terminated or interrupted.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a main part system configuration diagram illustrating a schematic configuration of a print control system including a print control apparatus according to a first embodiment;

FIG. 2 is an example of a job cancel setting screen for performing job cancel setting displayed on an operation screen of a display part according to the present embodiment;

FIG. 3 is an example of a cancel state screen displayed on the operation screen of the display part according to the present embodiment;

FIG. 4 is an example of a cancel target setting screen displayed on the operation screen of the display part according to the present embodiment;

FIG. 5 is an example of a release condition setting screen displayed on the operation screen of the display part according to the present embodiment;

FIG. 6 is an example of an inquiry screen displayed on the operation screen of the display part according to the present embodiment;

FIG. 7 is an example of a cancel time setting screen displayed on the display screen of the display part according to the present embodiment;

FIG. 8 is an example of a reception interval setting screen displayed on the operation screen of the display part according to the present embodiment;

FIG. 9 is an example of a reception job count setting screen displayed on the operation screen of the display part according to the present embodiment;

FIG. 10 is an explanatory diagram for explaining a case in which a job cancel instruction is accepted from each unit of the apparatus in the print control system according to the present embodiment;

FIG. 11 is a flowchart describing print control in the print control system including the print control apparatus according to the first embodiment;

FIG. 12 is a flowchart describing print control in the print control system including the print control apparatus according to a second embodiment;

FIG. 13 is an example of a job cancel candidate list screen displayed on the operation screen of the display part according to the present embodiment;

FIG. 14 is an example of a cancel job history screen displayed on the operation screen of the display part according to the present embodiment; and

FIG. 15 is a main part system configuration diagram illustrating a schematic configuration of a print control system including a print control apparatus according to a third embodiment.

### DETAILED DESCRIPTION

Hereinafter, one or more embodiments of the present invention will be described with reference to the drawings. However, the scope of the invention is not limited to the disclosed embodiments.

Below, with reference to the drawings, embodiments of a print control apparatus, a print control system, and a storage medium according to the present embodiment will be described. It should be noted that the following embodiments are provided with various limitations that are technically preferable for carrying out the present invention, but the scope of the present invention is not limited to the following embodiments and illustrated examples.

### First Embodiment

### [Configuration of Print Control System]

According to the present embodiment, the print control apparatus is included in a print control system.

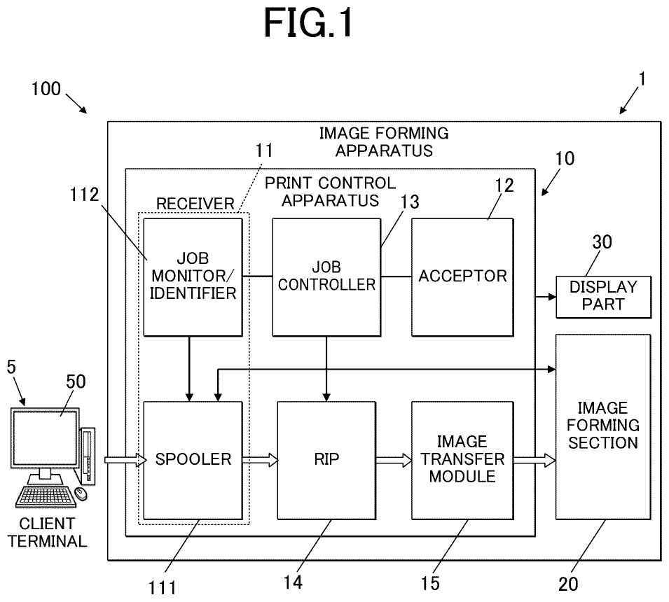

FIG. 1 is a diagram illustrating a schematic configuration of a print control system according to a first embodiment.

As illustrated in FIG. 1, the print control system 100 according to the present embodiment includes an image forming apparatus 1 and a client terminal 5. The image forming apparatus 1 and the client terminal 5 are connected to various communication networks, for example, a LAN and are communicable with each other via the communication networks. Note that a communication method between the image forming apparatus 1 and the client terminal 5 is not particularly limited.

The client terminal 5 is, for example, a computer device such as a personal computer (PC) operated by a user. The client terminal 5 may be a portable device such as a tablet PC.

In accordance with a user's operation or the like, the client terminal 5 transmits a plurality of small jobs based on a print instruction to the image forming apparatus 1 via the communication network.

According to the present embodiment, the plurality of small jobs are a plurality of jobs divided so that a size of one unit is small. It is assumed that a plurality of small jobs having such a small size are successively sent from the client terminal 5. As such a print job, a job (variable printing) in which a part of a document includes a variable element (so-called variable element) is conceivable.

For example, variable printing is performed in which a name field, an amount of money field, and the like are different for each person and other parts are common in a leaflet addressed to an individual, various usage specifications, and the like. In such variable printing, a document for one person including variable elements is defined as one job. Then, a plurality of small jobs divided one by one are sent from the client terminal 5 to the image forming apparatus 1, for example, in a group corresponding to the number of persons. Note that the “plurality of small jobs” are not limited to jobs related to variable printing.

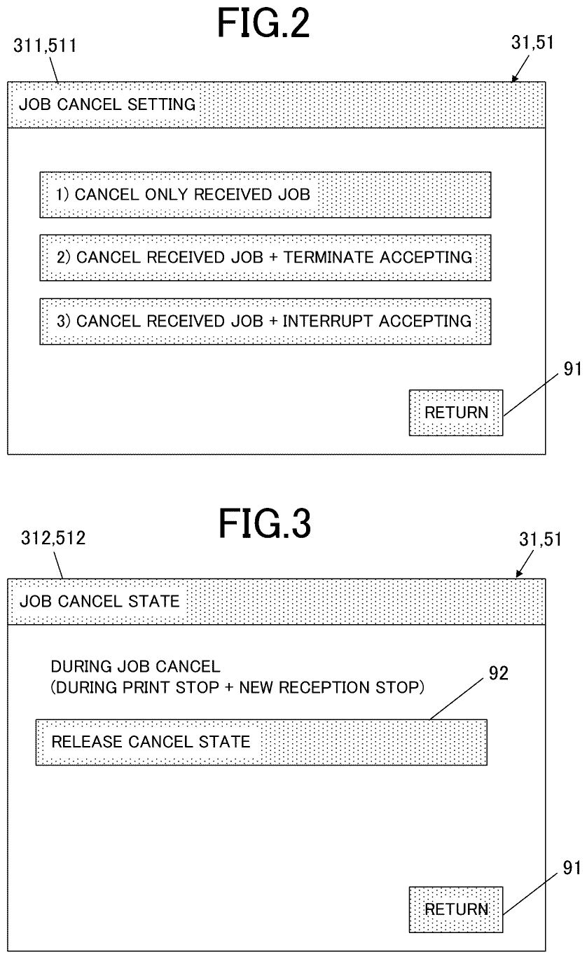

The client terminal 5 accesses, for example, the print control apparatus 10 of the image forming apparatus 1, and causes the display part 50 (see FIG. 2 and the like) to display an operation screen 51 (see FIG. 2 and the like) provided by the print control apparatus 10. Then, when the user performs an operation of inputting an instruction from the operation screen 51, an operation instruction signal according to the operation is transmitted to the print control apparatus 10 of the image forming apparatus 1.

Note that although not illustrated, the client terminal 5 itself may include a job management application program (hereinafter referred to as “job management AP”) and the like. In this case, even when the operation screen 51 or the like is not provided from the print control apparatus 10 side, the operation screen by the job management AP can be displayed on the display part 50.

The image forming apparatus 1 includes an image forming section 20 and a print control apparatus 10 (hardware processor). The print control apparatus 10 is a controller that controls an operation (printing operation) and the like by the image forming section 20. The print control apparatus 10 and the image forming section 20 can transmit and receive information to and from each other.

The image forming section 20 forms an image on a medium such as various types of sheets.

That is, the image forming section 20 is a printer that executes a print job in accordance with a print instruction received from the print control apparatus 10. A method of image formation in the image forming section 20 is not particularly limited. That is, the image forming section 20 may form the image by an electrophotographic method approach. Alternatively, the image may be formed by an inkjet method. Furthermore, the image forming section 20 may be a color printer or a monochrome printer.

The print control apparatus 10 is, for example, a computer including a controller configured of a central processing unit (CPU) or the like, a read only memory (ROM) which is a non-volatile memory, a random access memory (RAM) which is a volatile memory, and the like (all of which are not illustrated). The CPU, the ROM, and the RAM are connected to one another by an internal bus (not illustrated). The CPU reads various processing programs stored in, for example, the ROM and develops the programs in the RAM. Next, in cooperation with various programs expanded in the RAM, the CPU comprehensively controls operation of each part of the image forming apparatus 1 including the print control apparatus 10 and the image forming section 20, and performs various kinds of processing.

FIG. 1 illustrates a functional configuration of the print control apparatus.

As illustrated in FIG. 1, the print control apparatus 10 includes a receiver 11, an acceptor 12, and a job controller 13. The print control apparatus further includes a raster image processor (RIP) 14 and an image transfer module 15.

The receiver 11 receives the above-described “plurality of small jobs” from the client terminal 5.

Specifically, the receiver 11 receives, at a spooler 111, a print job (print data) transmitted from the client terminal 5 via the communication network.

The print data received by the spooler 111 is sequentially transmitted to the RIP 14. In the RIP 14, the print data is converted into image data that can be printed by the image forming section 20. The converted data is transmitted to the image transfer module 15. The image transfer module 15 transmits the converted image data to the image forming section 20. Thus, the image forming section 20 can execute the print job in accordance with the print instruction (print operation in accordance with the print data).

The receiver 11 according to the present embodiment includes a job monitor/identifier 112 in addition to the spooler 111.

The job monitor/identifier 112 transitions to a cancel state when the acceptor 12, which is described later, accepts a job cancel instruction. Then, a print job newly input to the spooler 111 is monitored.

The job monitor/identifier 112 of the receiver 11 can analyze characteristics of job data (print data) received from the client terminal 5. When the job monitor/identifier 112 shifts to the cancel state, it judges whether a print job newly input to the spooler 111 is a cancel target. Specifically, it is analyzed whether or not the feature is common to the job data received at the time when the acceptor 12 accepts the job cancel instruction among the jobs newly received by the receiver 11. The analysis result of the job monitor/identifier 112 is output to the job controller 13.

The print job that is analyzed by the job monitor/identifier 112 as having common features with the job data received at the time point when the acceptor 12 accepts the job cancel instruction is determined by the job controller 13 to be the cancel target. Next, the job controller 13 stops (cancels) the operation of each part related to printing for the job determined to be the cancel target.

When the cancel state of the job monitor/identifier 112 is released, the print job received by the spooler 111 is sent to the image forming section 20 and output (printed) as usual.

Job identification in the job monitor/identifier 112 as to whether or not the print job newly entering the receiver 11 is to be the cancel target will be described in detail later.

In what case the cancel state of the job monitor/identifier 112 is released will also be described in detail later.

The acceptor 12 accepts a job cancel instruction which is a printing terminate instruction or a printing interruption instruction. That is, when the user performs an operation input of an instruction to cancel the print job from the operation screen 51 or the like of the client terminal 5, an operation instruction signal corresponding to the input is output to the print control apparatus 10. When the operation instruction signal is sent to the print control apparatus 10, the acceptor 12 accepts the instruction content corresponding to the operation instruction signal.

Note that on what the user performs operation input is not limited to the operation screen 51 of the client terminal 5. For example, the display part 30 may be provided in the image forming apparatus 1 including the print control apparatus 10 (see FIG. 1). In this case, the user may perform operation input from an operation screen 31 (see FIG. 2 and the like) displayed on the display part 30 of the image forming apparatus 1. In this case, the acceptor 12 accepts instruction content corresponding to the operation instruction input from the operation screen 31 of the image forming apparatus 1. Note that in the following description, a reference sign such as “operation screen 31 or 51” indicates that either the operation screen 51 of the client terminal 5 or the operation screen 31 of the image forming apparatus 1 may be used.

When the acceptor 12 accepts the instruction, the acceptor 12 transmits the accepted instruction content to the job controller 13 described later.

Note that among the job cancel instructions, the “printing terminate instruction” is an instruction to stop both the printing operation of the print job and the reception of the print instruction. In other words, when the acceptor 12 accepts an instruction to terminate printing, the job controller 13, which will be described later, stops printing of the job that has already been received and is being printed. That is, not only the printing operation in the image forming section 20 is stopped, but also all the jobs remaining in the spooler 111, the RIP 14, the image transfer module 15 and the like are cancelled (processing is stopped). Thus, the printing operation is prevented from proceeding any further. The job controller 13 also stops printing of the job newly received by the receiver 11. Furthermore, after the time point at which the terminate instruction is accepted, the reception of the print instruction by the receiver 11 is also stopped.

In contrast, among the job cancel instructions, the “printing interruption instruction” is an instruction to stop the printing operation of the print job. That is, when the acceptor 12 has accepted the printing interruption instruction, the job controller 13 stops printing of the job that has already been received and is being printed. As in the case of the “printing terminate instruction”, the term “stop” means not only stopping the printing operation in the image forming section 20 but also canceling (stopping the processing of) all jobs remaining in the spooler 111, the RIP 14, the image transfer module 15, and the like. In addition, although printing of the job newly received by the receiver 11 is also stopped, reception of a print instruction by the receiver 11 is continued even after a time point at which an interruption instruction is accepted. In this case, the received job is stored and accumulated in the spooler 111 to be put on hold, and the transfer of the job to the image forming section 20 is stopped. Note that the job to be interrupted or terminated based on the job cancel instruction is, for example, the small job received when the job cancel instruction is accepted, or the small job to be printed next after the small job currently being printed.

Whether the job cancel instruction is the printing terminate instruction or the printing interruption instruction is instructed by the user's operation input from the operation screen 31 or 51, for example.

For example, according to the present embodiment, the job cancel setting screens 311 and 511 can be displayed on the operation screen 51 of the client terminal 5, the operation screen 31 of the image forming apparatus 1, or the like.

FIG. 2 is a view illustrating an example of a job cancel setting screen displayed on the operation screen. When the user wants to set the job cancel, job cancel setting screens 311 and 511 as illustrated in FIG. 2 are displayed on the operation screens 31 and 51.

As illustrated in FIG. 2, the content (type) of job cancel can be set on the job cancel setting screens 311 and 511.

For example, when 1) is selected by the user, only the received job is cancelled (stopped). In this case, the job controller 13 controls each part so that the received job is not printed after the time point of acceptance of the job cancel instruction.

For example, when 2) is selected, the job controller 13 cancels (stops) the received job. Then, the job controller 13 performs control so that no new job is received after the time point of acceptance of the job cancel instruction (terminate instruction).

Furthermore, for example, when 3) is selected, the job controller 13 cancels (stops) the received job. Then, the job controller 13 continues reception of the new job after the time point of acceptance of the job cancel instruction, but performs control as a suspended state so that the job is not printed (interruption instruction). For example, the processing of each section is stopped, such as stopping transfer to the image forming section 20.

Note that in the illustrated example, it is possible to return from the job cancel setting screens 311 and 511 to the initial screen (not illustrated) or the like by operating a “return button” 91.

In the job cancel setting screens 311 and 511, when the user selects any one of 1) to 3), the job cancel instruction having content corresponding to the selection is input. When the job cancel instruction is input, the acceptor 12 accepts the job cancel instruction in accordance with the operation. Next, the job cancel instruction accepted by the acceptor 12 is output to the job controller 13. In this case, when the job controller 13 receives the job cancel instruction, it is preferable that the job controller 13 causes the operation screens 31, 51, or the like to display the cancel state screens 312, 512 indicating that the job cancel is being executed (continued).

FIG. 3 shows an example of a cancel state screen when, for example, “2)” in FIG. 2 is selected. In FIG. 3, it is displayed that printing of the received job is stopped, and furthermore, reception of the new job after the time point of acceptance of the job cancel instruction is also stopped. As shown in FIG. 3, it is preferable that a “cancel release button” 92 for releasing the cancel state is displayed on the cancel state screens 312, 512.

Note that printing of all received jobs and reception of all new jobs may be stopped during execution of job cancel (during continuation), but in the present embodiment, the job monitor/identifier 112 identifies whether or not a newly input print job is the cancel target.

That is, when the job cancel instruction is accepted by the acceptor 12, the acceptance of the job cancel instruction is notified to the job monitor/identifier 112 via the job controller 13. Thus, as described above, the job monitor/identifier 112 enters the cancel state, monitors the print job newly entering the spooler 111, and judges whether or not the print job is the cancel target.

When the job cancel is continued, the user can set, for example, on the operation screen 31 or 51, what print jobs the job monitor/identifier 112 judges to be the cancel target.

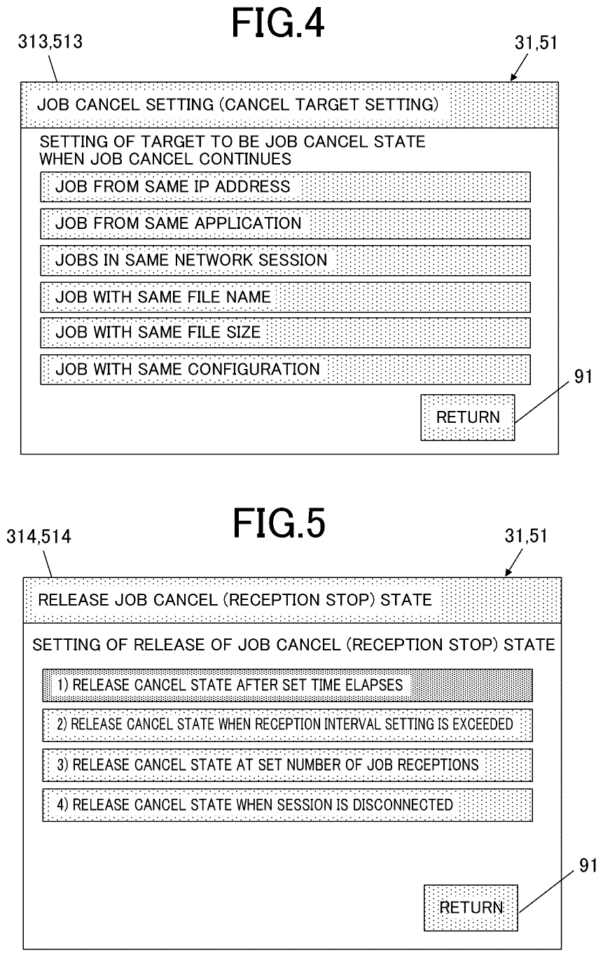

FIG. 4 illustrates an example of a cancel target setting screen for setting the type of the print job as the cancel target when job cancel is continued.

In FIG. 4, six cases are given as examples of jobs to be the cancel target.

For example, the job is the job from the same IP address as that received when the job cancel instruction is accepted, the job from the same application, or the job transmitted from the same network session. In such a case, it can be estimated that the job is a series of jobs transmitted by the same user.

Further, for example, if the job has the same file name as that received when the job cancel instruction is accepted, it can be considered that a series of jobs continues. Further, for example, there is a case where the print job is a job having the same file size as that received when the job cancel instruction is accepted. In this case, it is highly likely that a series of small jobs is continuing.

Furthermore, when job cancel is continued, the job monitor/identifier 112 may also monitor and detect the content of the print job. For example, there is a case where job data constituting a print job has a similar configuration to that of a job that has been received when the job cancel instruction has been accepted. In this case, it is highly likely that a series of small jobs is continuing.

The “same configuration” is, for example, a case where the number of images, the number of graphics, the number of texts, and the like of the job data constituting the print job are the same. In such a case, the job monitor/identifier 112 judges which print job is to be the cancel target.

Note that in the case of a job with “similar file size” or a job with “similar configuration”, a threshold for judging “similar” is provided. Then, if it is within the range of the threshold, it is preferable that it is judged as “similar” in the job monitor/identifier 112.

In contrast, in a case where the IP address or the like of the transmission source has changed, a case where the file name has changed, or the like, there is a high possibility that the user, the content of the job, or the like has been switched. For example, there is a possibility that a job transmitted from a different application is an interrupt job different from the job received when the job cancel instruction is accepted. Furthermore, in a case where the file size or configuration of the job has changed, it is highly likely that the job has been switched from the series of small jobs that were being received when the job cancel instruction was accepted to another job.

Therefore, in such a case, the job monitor/identifier 112 judges that the newly received job is not to be the cancel target. For a job that is not to be the cancel target, the job controller 13 controls each part of the apparatus so that printing is performed as usual.

In this way, even if the user does not individually judge whether or not the job is to be the cancel target or does not set each time, it is possible to automatically judge the job to be the cancel target if a certain condition is satisfied. Therefore, the burden on the user is reduced.

It should be noted that what is shown in FIG. 4 is an example, and elements for judging whether or not to judge as the cancel target may be other than what is shown here. Furthermore, even the items listed in FIG. 4 may be customizable, such as being appropriately removed if the user wants to remove the item from the item for judging the cancel target.

The acceptor 12 according to the present embodiment can accept a release instruction to release the job cancel instruction in addition to the job cancel instruction from the user.

The release instruction is an instruction to release the job cancel instruction after the accepting unit accepts the job cancel instruction from the user. For example, the user can manually release the job cancel state by operating the “cancel release button” 92 in FIG. 3. In addition, according to the present embodiment, a condition for releasing the job cancel state can be defined in advance. In this case, when the defined condition is satisfied, it is determined that there is a release instruction, and the job cancel state is automatically released.

When the acceptor 12 has accepted the release instruction, the job controller 13 described later resumes, at the timing of acceptance of the release instruction, the operation of each section that has been stopped in accordance with the job cancel instruction. As a result, for example, the cancel state of the job monitor/identifier 112 is also released. In a case where reception of a new job by the receiver 11 or the like has been stopped, the reception is resumed.

Note that the “timing at which the release instruction has been accepted” is a timing at which the “cancel release button” 92 has been operated in a case of release by the user's operation of the “cancel release button” 92. In addition, in a case of automatic release in a case where a predetermined release condition is satisfied, it is timing at which the release condition is satisfied.

According to the present embodiment, the user can also set when to release the job cancel state, that is, the release condition of the job cancel state from the operation screen 31, 51, or the like.

FIG. 5 is an example of a release condition setting screen for setting a release condition under which the job cancel state is released.

For example, in the example illustrated in FIG. 5, in 1), the job cancel state is released after a predetermined set time has elapsed since the acceptor 12 has accepted the job cancel instruction. Furthermore, in a case where the reception interval becomes equal to or longer than a predetermined time in 2), the job cancel state is released. In addition, in 3), the job cancel state is released when the number of times of reception reaches a predetermined number of times. Furthermore, in 4), the job cancel state is released when the session is disconnected.

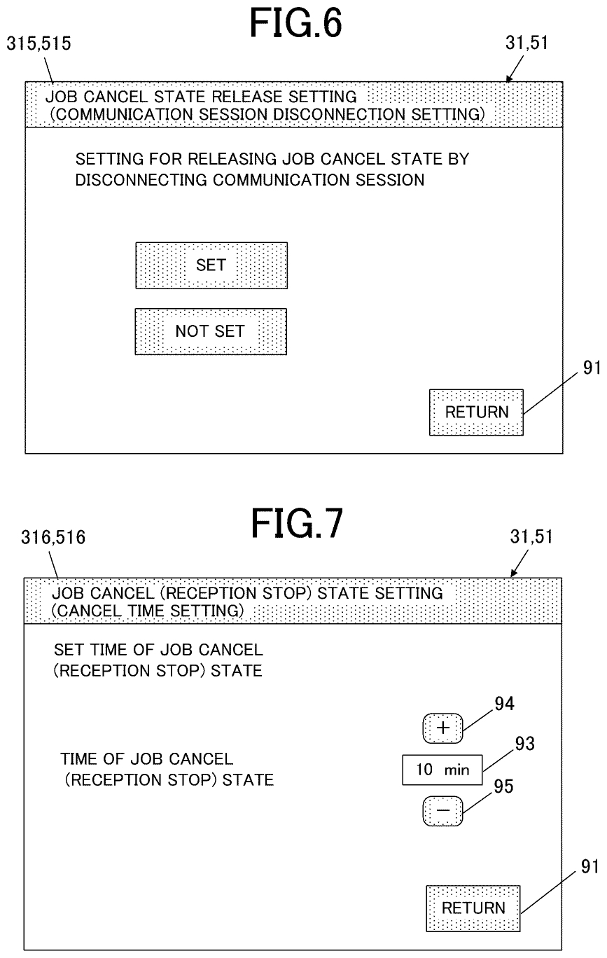

FIG. 6 is an example of the inquiry screen 315, 515 inquiring whether to perform setting of “4)”. When the user selects “set” in the inquiry screens 315 and 515 illustrated in FIG. 6, the field of “4)” enters a selected state in the release condition setting screens 314 and 514 in FIG. 5.

In any case, the job cancel state is automatically released at a timing when there is a possibility that the situation has changed from the time when the job cancel instruction is received. Note that the release condition is not limited to the condition illustrated in FIG. 5. In addition, it may be possible to customize by the user, such as adding any condition to the release condition.

When the user selects one of the exemplified condition on the release condition setting screens 314 and 514, the job cancel state is released when the selected release condition is satisfied. FIG. 5 illustrates a case where “1)” is selected by the user.

In a case where the user selects “1)”, for example, cancel time setting screens 316 and 516 as illustrated in

FIG. 7 are further displayed on the operation screens 31 and 51 or the like. On the cancel time setting screens 316 and 516, it is possible to set how long the job cancel state continues to release the job cancel state or set a timeout time. In this case, the job monitor/identifier 112 measures, with the timer function, an elapsed time from the shift to the job cancel state.

For example, in the example illustrated in FIG. 7, a set time display field 93, a “plus button” 94 for lengthening the set time, and a “minus button” 95 for shortening the set time are displayed on the screen.

In the illustrated example, the setting is such that the job cancel state is released after 10 minutes have elapsed since the acceptor 12 accepted the job cancel instruction.

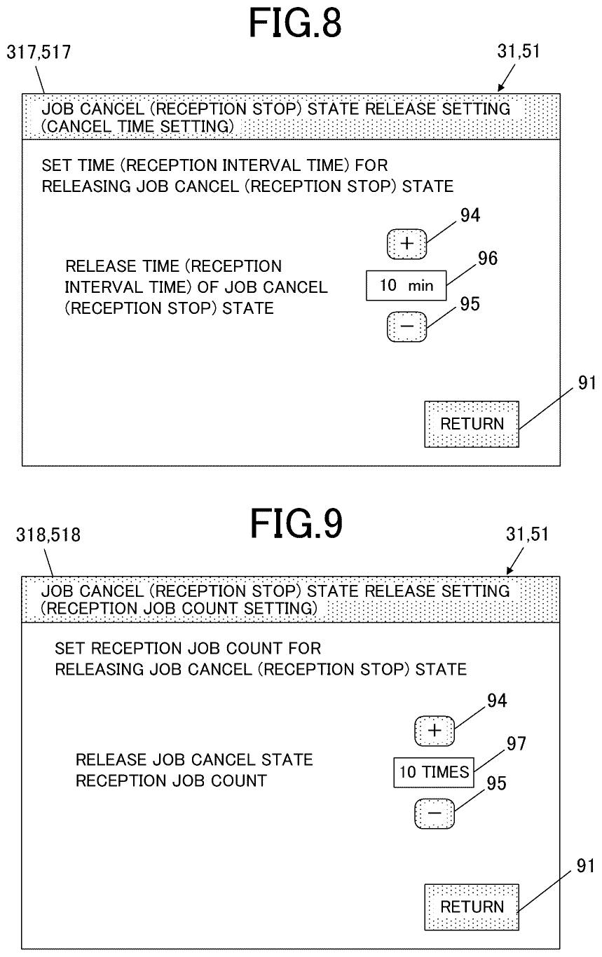

Further, when the user selects “2)”, for example, reception interval setting screens 317 and 517 as shown in FIG. 8 are further displayed on the operation screens 31 and 51. On the reception interval setting screens 317 and 517, it is possible to set how long a state in which there is no reception from the client terminal 5 continues after the acceptor 12 accepts the job cancel instruction to release the job cancel state. Also in this case, the job monitor/identifier 112 measures, with the timer function, the elapsed time since the acceptor 12 accepted the job cancel instruction.

For example, in the example illustrated in FIG. 8, a set time display field 96, a “plus button” 94 for lengthening the set time, and a “minus button” 95 for shortening the set time are displayed on the screen.

In the illustrated example, the job cancel state is set to be released in a case where nothing is received from the client terminal for 10 minutes after the acceptor 12 has accepted the job cancel instruction.

Further, when the user selects “3)”, for example, reception job count setting screens 318 and 518 as shown in FIG. 9 are further displayed on the operation screens 31 and 51. On the reception job count setting screens 318 and 518, it is possible to set how many times the job is received from the client terminal 5 after the acceptor 12 accepts the job cancel instruction to release the job cancel state. In this case, the job monitor/identifier 112 counts the number of jobs received from the client terminal 5. Then, when the predetermined number of times is reached, it is judged that the release condition is satisfied.

For example, in the example shown in FIG. 9, a count display field 97, a “plus button” 94 for increasing the number of times, and a “minus button” 95 for decreasing the number of times are displayed on the screen.

In the illustrated example, the job cancel state is set to be released when a job is received from the client terminal 5 ten times.

Furthermore, according to the present embodiment, the acceptor 12 not only accepts user's operation input from the operation screens 31 and 51 or the like but also monitors the state of the apparatus. Then, when detecting an abnormality or the like of the apparatus, the acceptor 12 transmits, to the job controller 13, a notification that the job being executed will be cancelled.

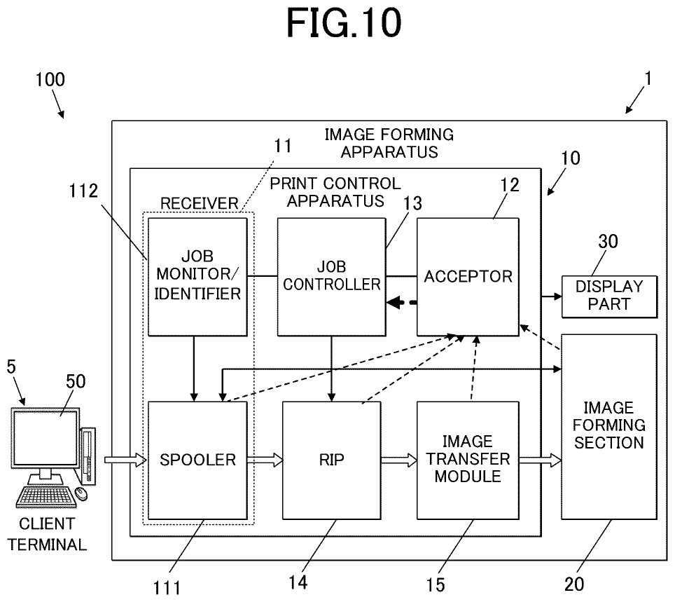

FIG. 10 is an explanatory diagram for explaining a case where the accepting unit accepts a job cancel instruction (cancel request) from each unit of the apparatus in the print control system of the present embodiment. In FIG. 10, a cancel request from each unit of the apparatus is indicated by a broken line arrow. Furthermore, transmission of a cancel request from the acceptor 12 to the job controller 13 in this case is indicated by a thick broken line arrow.

To be specific, as illustrated in FIG. 10, in a case where some abnormality occurs in the spooler 111 of the receiver 11, the RIP 14, the image transfer module 15, or the image forming section 20, a cancel request is notified from each of these sections to the acceptor 12. Upon receiving the cancel request, the acceptor 12 notifies the job controller 13 to cancel the job being executed.

Note that the notification from the acceptor 12 to the job controller 13 preferably includes information on which component has developed the abnormality. In this case, for example, if an abnormality occurs in the RIP 14, the image transfer module 15, or the image forming section 20, the job controller 13 may cancel the job by either “terminating printing” or “interrupting printing”. On the other hand, when an abnormality has occurred in the spooler 111, the job controller 13 notifies, as job cancel, each section of the apparatus of “terminate printing” to stop both the printing operation of the print job and the reception of the print instruction.

### [Operation of Print Control System Including Print Control Apparatus and Print Control Method]

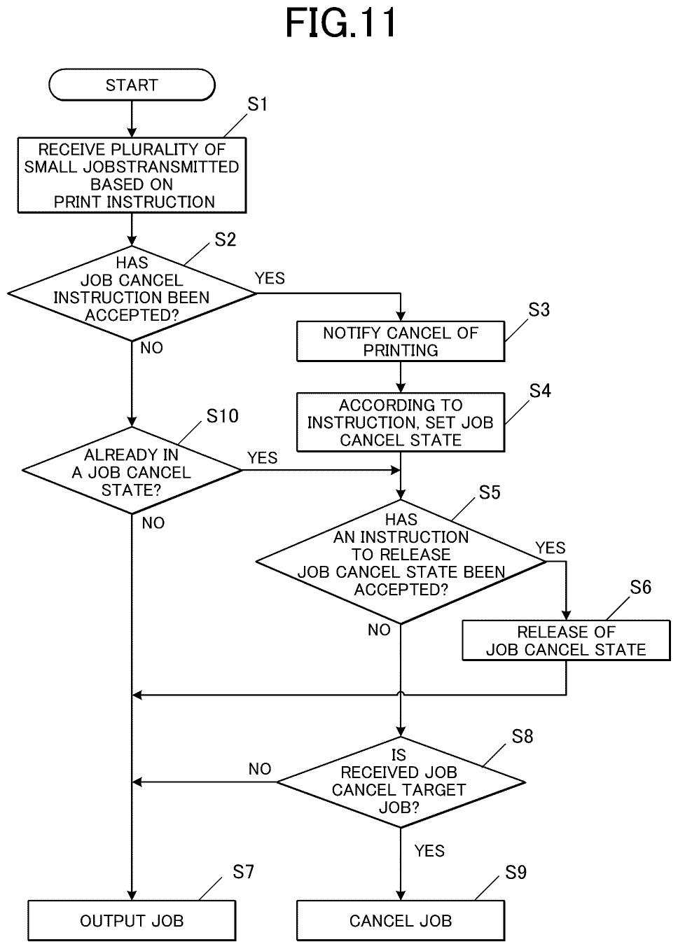

Next, an operation of the print control system 100 including the print control apparatus and a print control method will be described with reference to FIG. 11 and the like.

FIG. 11 is a flowchart illustrating a flow of cancel of a print job and release of a job cancel state according to the present embodiment.

As shown in FIG. 11, when a plurality of small jobs are transmitted from the client terminal 5 to the image forming apparatus 1 based on a print instruction, the plurality of small jobs are received by the spooler 111 of the print control apparatus 10 (step S1).

The job controller 13 judges whether the acceptor 12 has accepted a job cancel instruction (step S2). That is, the job controller 13 judges as needed whether or not it has been notified by the acceptor 12 that it has accepted a job cancel instruction.

When notified by the acceptor 12 that the job cancel instruction has been accepted (step S2; YES), the job controller 13 notifies the sections of the apparatus such as the spooler 111 and the job monitor/identifier 112 which are the receiver 11, the RIP 14, the image transfer module 15 and the image forming section 20 that the printing job has been cancelled (step S3).

Upon receiving a notification of cancel of the print job from the job controller 13, each part of the apparatus sets a job cancel state according to the job cancel instruction (step S4). To be specific, the spooler 111, the RIP 14, the image transfer module 15, and the image forming section 20 each stop the job being executed.

Furthermore, when the acceptor 12 receives the job cancel instruction, the job monitor/identifier 112 transitions to the cancel state and monitors the print job that newly enters the spooler 111.

Furthermore, in the present embodiment, the job monitor/identifier 112 after the transition to the cancel state confirms the state of a job newly entering the spooler 111, and identifies (judges) whether or not the job is to be the cancel target.

During the continuation of the job cancel state, the job controller 13 further judges whether the acceptor 12 has accepted the release instruction for the job cancel state (step S5). That is, the job controller 13 judges whether or not it has been notified by the acceptor 12 that it has accepted the instruction to release the job cancel state (step S5).

When notified by the acceptor 12 that the instruction to release the job cancel state has been accepted (step S5; YES), the job controller 13 releases the cancel state of each part of the apparatus (step S6), and causes the job to be output as usual (step S7).

That is, in a case where the reception itself of the receiver 11 has been cancelled (in a case of a printing

terminate instruction), the reception of the job is resumed, and the received job is sent to the image forming section 20 via the RIP 14 and image transfer module 15. In a case where the received job is on hold (in a case of a printing interruption instruction), the jobs accumulated in the spooler 111 are sequentially sent to the image forming section 20 via the RIP 14 and image transfer module 15. Next, the image forming section 20 performs a printing operation in accordance with the print instruction.

On the other hand, when there is no notification from the acceptor 12 that a job cancel state release instruction has been accepted (step S5; NO), the job controller 13 further determines whether or not a job constituting the received print instruction is a job to be the cancel target (step S8).

Specifically, the job controller 13 acquires, from the job monitor/identifier 112 after transition to the cancel state, the identification result as to whether or not the job entering the spooler 111 is to be the cancel target. Next, the job controller 13 determines, among newly received print jobs, the print job judged to be the cancel target by the job monitor/identifier 112 as the print job to be the cancel target (step S8; YES), and cancels the job (step S9).

On the other hand, when the job constituting the received print instruction is not the job to be the cancel target (step S8; NO), the job controller 13 sends the job to the image forming section 20 from the spooler 111 sequentially via the RIP 14 and the image transfer module 15. Next, in the image forming section 20, outputting (printing operation) is performed according to the print instruction (step S7).

Furthermore, when there is no notification from the acceptor 12 that a job cancel instruction has been accepted (step S2; NO), the job controller 13 further judges whether or not each part of the apparatus is already in a job cancel state (job cancel is being continued) (step S10).

If it is the job cancel state (step S10; YES), the flow advances to step S5 to execute the subsequent processing.

On the other hand, if it is not the job cancel state (step S10; NO), the job is sent from the spooler 111 to the RIP 14, the image transfer module 15, and the image forming section 20 as usual. Next, in the image forming section 20, outputting (printing operation) is performed according to the print instruction (step S7).

### [Effects]

As described above, the print control apparatus 10 according to the present embodiment includes the receiver 11, the acceptor 12, and the job controller 13. When a receiver 11 receives a plurality of small jobs transmitted from the client terminal on the basis of the print instruction, the controller 13 performs control so as to perform printing on the basis of the received small job. Furthermore, the job cancel instruction, which is the printing terminate instruction or the printing interruption instruction, is accepted by the acceptor 12. Then, when the job cancel instruction is accepted by the acceptor 12 during reception of the plurality of small jobs by the receiver 11, the controller 13 performs control to terminate or interrupt printing based on the small jobs.

Thus, the progress of the printing-related processing is stopped after the time point at which the job cancel instruction has been accepted. Therefore, the execution of not only the job currently being executed but also the small jobs continuously sent from the client terminal 5 can be promptly stopped.

Note that the job to be terminated or interrupted based on the job cancel instruction is, for example, the small job received when the job cancel instruction is accepted, or the small job to be printed next after the small job currently being printed.

Further, according to the present embodiment, when the acceptor 12 accepts the instruction to terminate printing, the job controller 13 stops printing of the job that is being printed. In addition, printing of the job newly received by the receiver 11 is also stopped. Then, after the time point at which the terminate instruction is accepted, the reception of the print instruction by the receiver 11 is also stopped.

In this way, by canceling the reception of the job itself, it is possible to reliably stop the progress of the process related to printing after the time point at which the acceptor 12 accepts the job cancel instruction.

Furthermore, according to the present embodiment, when the acceptor 12 accepts the printing interruption instruction, the job controller 13 stops printing of the job that is being printed. In addition, printing of the job newly received by the receiver 11 is also stopped. However, even after the time point at which the interruption instruction is accepted, the reception of the print instruction by the receiver 11 is continued.

Thus, the progress of printing-related processing is stopped after the time point at which the job cancel instruction has been accepted. On the other hand, when the job cancel state is released, the stopped printing operation of the job can be promptly resumed.

Furthermore, the acceptor 12 of the present embodiment is capable of accepting the job cancel instruction and the release instruction to release the job cancel instruction from the user. When the acceptor 12 receives the release instruction for releasing the job cancel instruction after accepting the job cancel instruction, the job controller 13 restarts the operation of each part which has been stopped at the timing of receiving the release instruction.

As a result, it is possible to easily cancel a job and release the cancel state by a user operation.

The print control apparatus 10 according to the embodiment includes a timer function. Next, the job controller 13 according to the present embodiment restarts the operation of each section that has been stopped at a timing when a predetermined time has elapsed after the acceptor 12 accepted the job cancel instruction.

Thus, when the predetermined time has elapsed, the printing operation of the job stopped by the job cancel instruction can be automatically resumed without the user's individual operation.

Furthermore, the print control apparatus 10 according to the present embodiment includes a count function of counting the number of jobs. Then, after the acceptor 12 accepts the job cancel instruction, the job controller 13 of the present embodiment restarts the operation of each unit that has been stopped at the timing when the number of jobs received by the receiver 11 reaches the set predetermined number of jobs.

Thus, when the job is received the predetermined number of times, the printing operation of the job stopped by the job cancel instruction can be automatically restarted without individual operation by the user.

The job monitor/identifier 112 of the receiver 11 in the embodiment can monitor the state of reception of data from the client terminal 5. Next, after accepting the job cancel instruction, the job controller 13 resumes the stopped operation of each part at the timing when the communication from the client terminal 5 to the receiver 11 is interrupted for a predetermined time or longer.

In a case where the communication from the client terminal 5 is interrupted, it is assumed that the user is switched or the type of job is changed. In such a case, it is possible to automatically release the job cancel state and resume the printing operation without the user's individual operation.

The job monitor/identifier 112 of the receiver 11 in the embodiment is also capable of analyzing the characteristics of the job data received from the client terminal 5. The job monitor/identifier 112 analyzes whether or not a feature of a job newly received by the receiver 11 is common to a feature of the job data received at the time when the acceptor 12 accepts the job cancel instruction. The job controller 13 determines the job having “a common feature” as the cancel target. Then, the operation of each unit related to printing is stopped for the job that is the cancel target.

The job data having a common feature is often a series of jobs. For this reason, the job cancel state is continued even if the job cancel instruction is not given again for those having a common feature. As a result, it is possible to reduce the burden of the user's operation. Furthermore, it is possible to cause a printing operation to be performed for a new job that is distinguished from the job for which the job cancel instruction has been accepted, and thus it is possible to smoothly control printing.

The acceptor 12 according to the present embodiment can accept an error signal from each unit of the apparatus as the job cancel instruction. When the acceptor 12 accepts the error signal from each part of the apparatus, the job controller 13 stops the operation of each part related to printing.

Thus, even when the user does not notice the abnormality or the cancel instruction is delayed, the job cancel state can be automatically and quickly set.

Furthermore, according to the present embodiment, it is possible to confirm, on the display parts 30 and 50, a history list of jobs that the job controller 13 has determined to be the cancel target.

Thus, the user can easily confirm, on the display parts 30 and 50, which of the jobs instructed to be printed has been canceled.

### Second Embodiment

Next, a second embodiment of the print control apparatus, the print control system, and the storage medium according to the present embodiment will be described. Note that the handling of the job to be the cancel target in the present embodiment is different from that in the first embodiment. The apparatus configuration is the same as that described in the first embodiment, and thus the description thereof will be omitted. In the following, differences from the first embodiment in particular will be described.

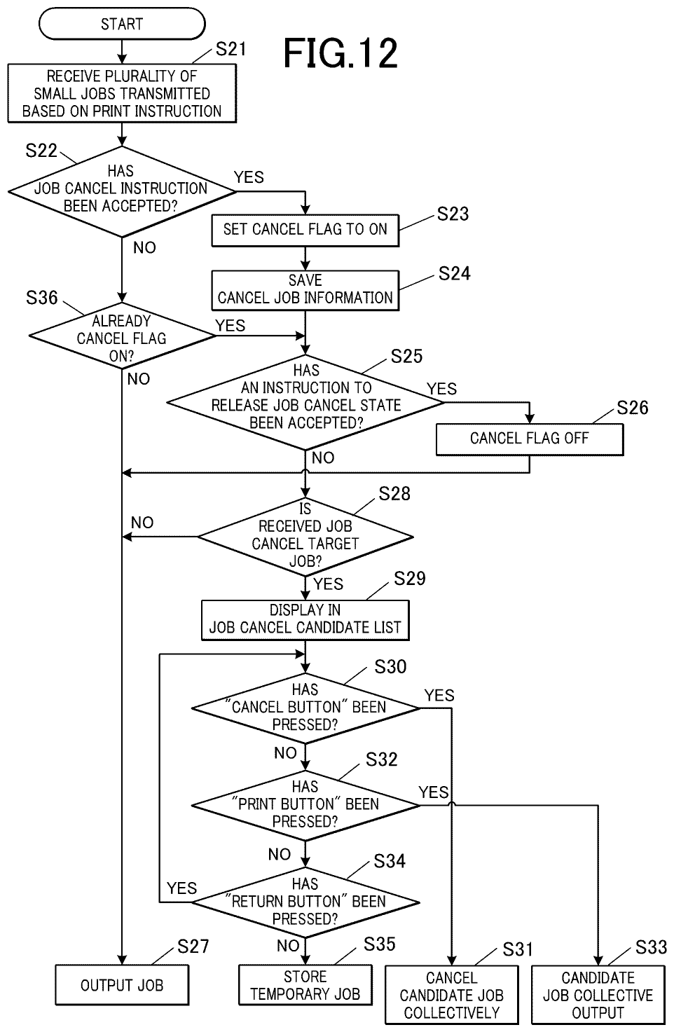

FIG. 12 is a flowchart illustrating print control in the present embodiment, in particular, a flow of cancel of a print job and release of a job cancel state. Note that since step S21 and step S22 illustrated in FIG. 12 are the same as step S1 and step S2 illustrated in FIG. 11, description thereof will be omitted.

As shown in FIG. 12, when the acceptance of the job cancel instruction is notified from the acceptor 12 (step S22; YES), the job controller 13 sets a cancel flag in each unit of the apparatus such as the spooler 111 and the job monitor/identifier 112 which are the receiver 11, the RIP 14, the image transfer module 15, and the image forming section 20 (cancel flag ON; step S23). That is, similarly to step S3 in FIG. 11, the job controller 13 notifies each part of the apparatus that the print job has been cancelled.

When the cancel flag is turned on, each unit of the apparatus sets the job cancel state in accordance with the job cancel instruction (step S24). To be specific, the spooler 111, the RIP 14, the image transfer module 15, and the image forming section 20 each stop the job being executed.

Furthermore, when the acceptor 12 receives the job cancel instruction, the job monitor/identifier 112 transitions to the cancel state and monitors the print job that newly enters the spooler 111.

Furthermore, in the present embodiment, the job monitor/identifier 112 after transitioning to the cancel state analyzes the characteristics of the job newly entering the spooler 111, and identifies (judges) whether or not the job is to be the cancel target.

While the job cancel state continues, the job controller 13 judges, in a similar manner to step S5 in FIG. 11, whether the acceptor 12 has accepted the instruction to release the job cancel state (step S25). Next, when notified by the acceptor 12 that the instruction to release the job cancel state has been accepted (step S25; YES), the job controller 13 turns off the cancel flag to release the cancel state of each part of the apparatus (step S26), and causes the job to be output as usual (step S27).

On the other hand, when there is no notification from the acceptor 12 that the instruction to release the job cancel state has been accepted (step S25; NO), the job controller 13 further determines whether or not the job constituting the print instruction newly received by the receiver 11 is the job to be the cancel target (step S28).

Specifically, the job controller 13 acquires, from the job monitor/identifier 112 after transition to the cancel state, the identification result as to whether or not the job that enters the spooler 111 is to be the cancel target. Next, the job controller 13 determines that, among newly received print jobs, the print job judged by the job monitor/identifier 112 not to be the cancel target is not to be the cancel target (step S28; NO), and causes the job to be output as usual (step S27).

On the other hand, among the newly received print jobs, the print job judged to be the cancel target by the job monitor/identifier 112 is determined to be the cancel target by the job controller 13 (step S28; YES), and is displayed on job cancel candidate list screens 319 and 519 of the display parts 30 and 50 (step S29).

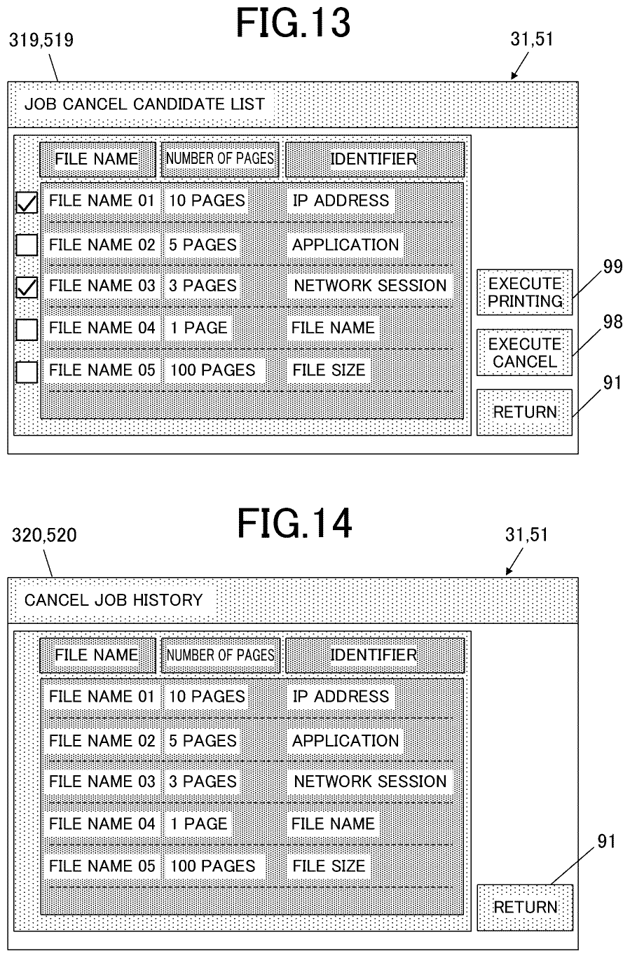

FIG. 13 is a diagram illustrating an example of the job cancel candidate list screen displayed on the display part. According to the present embodiment, processing of the job determined to be the cancel target by the job controller 13 is suspended, and the job is accumulated in the spooler 111 or the like of the receiver 11. The job controller 13 causes the operation screens 31, 51 of the display parts 30, 50 to display the job cancel candidate list screen 319, 519 as illustrated in FIG. 13, so that the user can confirm the job determined to be the cancel target.

For example, FIG. 13 illustrates a case where five print jobs with the file names 01 to 05 are to be the cancel target. As illustrated in FIG. 13, for each job, the number of pages, the reason why the job has been identified as the job to be the cancel target by the job monitor/identifier 112 (identifying means), and the like are displayed.

On the job cancel candidate list screens 319 and 519, a “cancel button” 98, a “print button” 99, a “return button” 91, and the like are displayed.

The job controller 13 judges whether the “cancel button” 98 in the job cancel candidate list screen 319, 519 has been pressed (step S30). If the “cancel button” 98 is pressed by the user (step S30; YES), the job controller 13 collectively cancels the jobs that are the candidates for cancel (step S31).

In this case, all of the cancel candidate jobs on the list may be cancelled, but in the present embodiment, the user can select the job for which cancel is to be fixed from among the cancel target jobs. In the example illustrated in FIG. 13, a file name 01 and a file name 03 are selected in the job cancel candidate list screens 319, 519. When the “cancel button” is pressed in this state, the cancel of the two jobs can be collectively fixed. The color or the like of the letters or the background of the job fixed to be cancelled may change, or the job may disappear from the list display of the job cancel candidate list screens 319, 519.

Note that the job cancel candidate list screens 319 and 519 shown in FIG. 13 are examples, and the screen configuration, the types of buttons, the arrangement, and the like can be changed as appropriate. For example, in addition to the buttons illustrated in FIG. 13, the job cancel candidate list screens 319 and 519 may be provided with a “collectively select button”, a “collectively release button”, and the like. In this case, it is possible to save the user the trouble of selecting jobs one by one. In a case where the number of jobs to be the cancel target is large or the like, the selection or the like can be collectively performed, so that the operation can be facilitated. It is preferable that the job for which cancel is fixed can be confirmed as the history.

For example, FIG. 14 is a diagram illustrating an example of cancel job history screens 320, 520 displayed on the display parts 30, 50.

FIG. 14 illustrates a case where all the jobs displayed on the job cancel candidate list screens 319 and 519 in FIG. 13 have been cancelled. In this way, since it is possible to confirm for which job the cancel has been fixed, the user can confirm the cancel state of the job. Thus, when there is a job that has been cancelled by mistake, it is possible to quickly confirm the job. Note that the cancel job history screens 320, 520 shown in FIG. 14 are examples, and the screen configuration, the types of buttons, the arrangement, and the like can be changed as appropriate.

If the “cancel button” 98 has not been pressed on the job cancel candidate list screen 319, 519 (step S30; NO), the job controller 13 further judges whether or not the “print button” 99 has been pressed on the job cancel candidate list screen 319, 519 (step S32). If the “print button” 99 has been pressed by the user (step S32; YES), the job controller 13 collectively outputs (prints in the image forming section 20) the jobs that are candidates for cancel (step S33).

Note that also in this case, all the cancel candidate jobs on the list may be output (printed), or only the jobs selected by the user among the cancel target jobs may be collectively output (printed). The output (printed) job is preferably deleted from the list display of the job cancel candidate list screen.

If the “print button” 99 has not been pressed (step S32; NO), the job controller 13 further judges whether the “return button” 91 has been pressed in the job cancel candidate list screen 319, 519 (step S34). If the “return button” 91 has been pressed by the user (step S34; YES), the job controller 13 returns to step S30 and repeats the subsequent processing.

On the other hand, if the “return button” 91 is not pressed (step S34; NO), the job controller 13 sets the jobs displayed as a list on the job cancel candidate list screens 319, 519 to a temporary storage state (that is, continuation of the hold state), and ends the process.

According to the present embodiment, the job controller 13 suspends the processing of the job determined to be the cancel target, and allows the display part 30, 50 to display the job to be the cancel target. Next, the input as to whether or not to fix the cancel of the job to be the cancel target displayed on the display parts 30, 50 is accepted.

As a result, the user can easily confirm which job is to be the cancel target. In addition, since whether to actually fix the cancel is also left to the user's judgement, the user can finally determine the handling of the job to be the cancel target, thus preventing the job from being unintentionally cancelled.

### Third Embodiment

Next, a third embodiment of the print control apparatus, the print control system, and the storage medium according to the present embodiment will be described. Note that in the present embodiment, the system configuration of the print control system is different from that of the first embodiment and the like. In particular, differences from the first embodiment and the like will be described below.

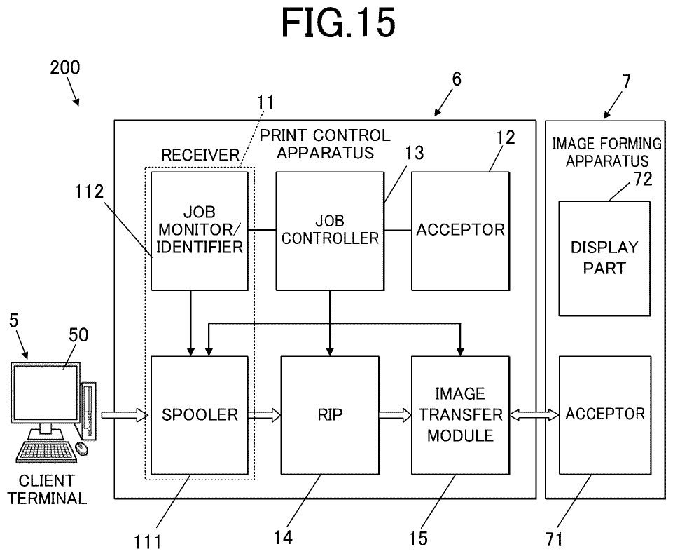

FIG. 15 is a diagram illustrating a schematic configuration of a print control system in the second embodiment.

As shown in FIG. 15, the print control system 200 of the present embodiment includes a client terminal 5, a print control apparatus 6 (hardware processor), and an image forming apparatus 7.

The print control apparatus 6 is a controller that controls an operation (printing operation) and the like by the image forming apparatus 7. The print control apparatus 6 is configured as an apparatus separate from the image forming apparatus 7, and is a computer including a CPU, a ROM, a RAM, and the like (not shown). The print control apparatus 6 is the same as the print control apparatus 10 (see FIG. 1) described in the first embodiment and the like, except that the print control apparatus 6 is separate from the image forming apparatus 7. Therefore, the components of the print control apparatus 6 similar to those of the print control apparatus 10 are denoted by the same names and reference numerals as those shown in FIG. 1, and the description thereof will be omitted.

The image forming apparatus 7 includes an acceptor 71 and accepts print data and the like from an external device. Furthermore, the image forming apparatus 7 includes a display part 72 for displaying an operation screen. The display part may be provided in the print control apparatus 6. In addition, a display part may be provided in each of the client terminal 5, the print control apparatus 6, and the image forming apparatus 7.

In the embodiment, various signals are transmitted and received between the print control apparatus 6 and the image forming apparatus 7 via, for example, Video IF.

For example, a print instruction is sent from the print control apparatus 6 side to the image forming apparatus 7. When the acceptor 12 of the print control apparatus 6 accepts a job cancel instruction, a notification indicating that the print job has been cancelled is sent to the image forming apparatus 7. From the image forming apparatus 7 side, for example, when some trouble occurs and the printing operation cannot be continued, the job cancel instruction (cancel request) for requesting to cancel the job is sent to the print control apparatus 6.

As shown in FIG. 15, even when the print control apparatus 6 and the image forming apparatus 7 are configured as separate apparatuses, the operation of each unit of the print control apparatus 6 is the same as that of the print control apparatus 10 described in the first embodiment and the like.

That is, when a plurality of small jobs are sent from the client terminal 5, the print control apparatus 6 receives the small jobs (print jobs) in the receiver 11. The print control apparatus 6 converts the print job received from the client terminal 5 into data printable by the image forming apparatus 7, and outputs the data to the image forming apparatus 7. Thus, the image forming apparatus 7 performs printing operation in accordance with the print instruction.

Furthermore, when a job cancel instruction is input from the operation screen 51 or the like of the display part 50, 72 or the like and is accepted by the acceptor 12, a notification that the print job has been cancelled is sent from the job controller 13 to the image forming apparatus 7. In this case, in the image forming apparatus 7, the job currently being executed is cancelled until a release instruction of the job cancel instruction is further transmitted.

In addition, all jobs which have been received from the client terminal 5 and remain in each unit (for example, RIP 14 or the like) in the print control apparatus 6 are also cancelled (processing is stopped). Furthermore, a job that has been newly sent to the print control apparatus 6 is also cancelled (reception is stopped) or put on hold, so that the job is not output to the image forming apparatus 7.

Accordingly, even in a case where the print control apparatus 6 and the image forming apparatus 7 are separate bodies, after the job cancel instruction is accepted, the output (printing) of the job is all cancelled until the cancel state is released. Therefore, it is possible to reliably prevent printing from being continued even after the job cancel instruction is accepted.

### Modification Example

Note that the present invention is not limited to the above-described embodiment, and it is needless to say that appropriate changes can be made without departing from the spirit of the present invention.

For example, in the above-described embodiment, only the print job that the job monitor/identifier 112 identifies as the job to be the cancel target among print jobs that newly enter the receiver 11 during execution (continuation) of job cancel is to be cancelled. However, for example, during execution (continuation) of job cancel, printing of all received jobs and reception of all new jobs input to the receiver 11 may be stopped (cancelled).

Furthermore, although the acceptor 12 accepts a notification requesting job cancel from each part of the apparatus when some trouble occurs in each part of the apparatus, the present invention is not limited to the case where the acceptor 12 accepts a notification from each part of the apparatus. For example, the job controller 13 may accept a notification from each part of the apparatus and notify of job cancel to each part of the apparatus continuing to operate.

In addition, the configurations and operations of the print control apparatus 10 and the print control system 100 including the print control apparatus 10 can be appropriately changed without departing from the scope of the present invention.

Although embodiments of the present invention have been described and shown in detail, the disclosed embodiments are made for purposes of illustration and example only and not limitation. The scope of the present invention should be interpreted by terms of the appended claims.

What is claimed is:

1. A print control apparatus comprising:
a hardware processor,
wherein the hardware processor,
receives a plurality of small jobs transmitted from a client terminal based on a print instruction,
performs control to perform printing based on the received small jobs,
accepts a job cancel instruction that is a printing terminate instruction or a printing interrupt instruction, and
when the job cancel instruction is accepted during reception of the plurality of small jobs, performs control such that the printing based on the small jobs is terminated or interrupted.

2. The print control apparatus according to claim 1, wherein a job to be terminated or interrupted based on the job cancel instruction is a small job that has been received when the job cancel instruction has been accepted, or a small job to be printed next after the small job currently being printed.

3. The print control apparatus according to claim 1, wherein reception of a small job is stopped after accepting the job cancel instruction.

4. The print control apparatus according to claim 1, wherein even after the job cancel instruction is accepted, reception of the small job continues.

5. The print control apparatus according to claim 1, wherein the hardware processor, when the printing terminate instruction is accepted, stops the printing of the job under printing execution, stops the printing of the job to be newly received, and stops the reception of the print instruction after the point of time when the printing terminate instruction is accepted.

6. The print control apparatus according to claim 1, wherein the hardware processor, when the printing interrupt instruction is accepted, stops the printing of the job under printing execution, and stops the printing of the job to be newly received, but continues the reception of the print instruction after the point of time when the printing interrupt instruction is accepted.

7. The print control apparatus according to claim 1,
wherein the hardware processor,
is configured to be capable of accepting the job cancel instruction and a release instruction to release the job cancel instruction from a user, and
after accepting the job cancel instruction from the user, resumes, when the release instruction to release the job cancel instruction is accepted, an operation of each section that has been stopped according to the job cancel instruction, at a timing when the release instruction is accepted.

8. The print control apparatus according to claim 1,
wherein the hardware processor,
keeps time, and
resumes, at a timing when a predetermined time has elapsed after accepting the job cancel instruction, operation of each section that has been stopped according to the job cancel instruction.

9. The print control apparatus according to claim 1,
wherein the hardware processor,
counts the number of jobs, and
after accepting the job cancel instruction, restarts the operation of each section stopped according to the job cancel instruction at a timing when the number of received jobs reaches a set predetermined number of jobs.

10. The print control apparatus according to claim 1,
wherein the hardware processor,
is configured to be capable of monitoring a reception state of data from the client terminal, and
after accepting the job cancel instruction, restarts, at a timing when communication from a client terminal is interrupted for a predetermined time or more, operation of each section that has been stopped according to the job cancel instruction.

11. The print control apparatus according to claim 1, wherein,
the hardware processor is configured to be capable of analyzing a feature of job data received from a client terminal, and
among newly received jobs, a job analyzed to have a common feature with the job data received at a point of time when the job cancel instruction is accepted is determined by the hardware processor as the job to be the cancel target, and the hardware processor stops the operation of each section related to printing for the job that is the cancel target.

12. The print control apparatus according to claim 1,
wherein the hardware processor,
is configured to be capable of accepting an error signal from each section of the apparatus as the job cancel instruction, and
stops operation of each section related to printing when the error signal is accepted from each section of the apparatus.

13. The print control apparatus according to claim 11,
further comprising a display part,
wherein,
processing of the job determined by the hardware processor to be the job to be the cancel target is suspended,
the display part displays the job determined to be the cancel target in a manner that the job can be confirmed, and
the hardware processor accepts an input as to whether to fix cancel of the job that is the cancel target displayed on the display part.

14. The print control apparatus according to claim 11,
further comprising a display part,
wherein the display part displays a list of history of the job determined to be the cancel target by the hardware processor in such a manner that the list can be confirmed.

15. A print control system, comprising:
a hardware processor, wherein the hardware processor,
receives a plurality of small jobs transmitted from a client terminal based on a print instruction,
performs control to perform printing based on the received small jobs, and
accepts a job cancel instruction that is a printing terminate instruction or a printing interrupt instruction;
a print control apparatus;
a client terminal that transmits a plurality of small jobs based on the print instruction; and
an image forming apparatus that executes a printing operation for the small job,
wherein,
the hardware processor performs control so as to terminate or interrupt printing based on the small job when the job cancel instruction is accepted during reception of the plurality of small jobs.

16. A non-transitory computer-readable storage medium storing a program causing a computer that controls a printing operation to execute,
receiving a plurality of small jobs transmitted from a client terminal based on a print instruction,
performing control to perform printing based on the received small job;
accepting a job cancel instruction that is a printing terminate instruction or a printing interrupt instruction, and
when the job cancel instruction is accepted during reception of the plurality of small jobs, performing control such that the printing based on the small jobs is terminated or interrupted.
